(19) United States
(12) Patent Application Publication
(10) Pub. No.: US 2022/0239987 A1
(43) Pub. Date: Jul. 28, 2022

(54) SYSTEMS AND METHODS FOR CREATING AND MODIFYING EVENT-CENTRIC MEDIA CONTENT

(71) Applicant: PicPocket Labs, Inc., Austin, TX (US)

(72) Inventors: Wolfram K. Gauglitz, Austin, TX (US); Joshua Mark LeBeau, Kansas City, MO (US); Haden Leslie Judd, Choufu City, Tokyo (JP)

(21) Appl. No.: 17/615,428

(22) PCT Filed: Mar. 31, 2020
(86) PCT No.: PCT/US2020/026045

§ 371 Date: Nov. 30, 2021

Related U.S. Application Data
(60) Provisional application No. 62/855,857, filed on May 31, 2019.

(51) Int. Cl. H04N 21/472; G06F 3/04842; G06F 16/487; G06F 16/48; H04N 21/854

(52) U.S. Cl. CPC H04N 21/47205; G06F 3/04842; H04N 21/854; G06F 16/489; G06F 16/487

(57) ABSTRACT

Systems and methods for creating video content, or Stories, from media captured at an event are disclosed. An Event can be defined using both location parameters (e.g. geofences or geographical envelopes) and temporal windows or envelopes. Media elements, such as images or video clips, captured at the Event (e.g. within the geographical and temporal Event envelopes) can be verified or filtered based on the defined Event, and provided to one or more users to create an EventStory that includes a sequence of selected media elements, Audio and/or video narration can be added to the sequenced EventStory. Other users can be granted permission to create or modify an EventStory corresponding to a defined Event. The finalized EventStory can be shared, either through a social media application/platform or by being stored in a conventional video format.

### CROSS-REFERENCE TO RELATED APPLICATION(S)

The present application is a 371 U.S. national phase application which claims priority to PCT/US2020/026045 filed Mar. 31, 2020 which relates to and claims priority from U.S. Provisional Patent Application Ser. No. 62/855,857 filed May 31, 2019, the disclosure of which is incorporated herein by reference in its entirety.

### FIELD OF THE DISCLOSURE

The present disclosure relates generally to social media platforms, and more specifically to methods and systems for creating multimedia files associated with a predefined event that includes both geographical and temporal limitations.

### BACKGROUND INFORMATION

Social media platforms, such as those associated with Snapchat, Facebook and Instagram, currently provide users with the ability to contribute photo and video content in a format known as a “Story”. A Story is essentially a running history of photo and video content contributed by a user of the social media platform. Each of the pieces of individual content which are contributed by a user is available for viewing for a set period of time by other users. This time period can be established by the user when the content is first added to their Story. The content contributed to a Story by a user is thus ephemeral, and lasts only for a short period of time (typically twenty four hours), after which the contributed content is removed from a Story in a first-in, first-out fashion.

A user of social media platforms that provide the Story feature can typically add as many pieces of content to their Story as they wish, and this content may come from various sources. Thus, for example, users may add content which was taken in real-time via a camera operated by the software application associated with a platform, or they may add content from a source external to the software application but accessible to it (such as, for example, media stored in the Gallery on an Android device, or the Camera Roll on a device running iOS).

At present, the foregoing platforms also allow a user to augment content with various personalized photo products. Thus, for example, these platforms can allow a user to associate stickers, lenses, filters, geofilters, or the like with certain content. Such augmentations may be added to, or superimposed over, individual pieces of content at the time the content is being contributed. These platforms may also allow a user to create or add such media as augmented reality (AR) content or interactive animations to a Story. Social media platforms may further allow a user to create or add drawings or text to a Story. The drawings or text may be created with various instruments (such as, for example, styluses or touch-sensitive pads or displays), and may utilize various colors, fonts or typefaces.

A Story lives and breathes on the platform it was created on. In certain situations, such Stories may be shared among certain limited platforms. For example, Stories created on Facebook may also be shared across limited applications or platforms, such as Instagram, Messenger, and Whatsapp, due to Facebook's ability to manage compatibility and interoperability as a result of its ownership of these additional social media platforms.

While social media platforms such as Snapchat, Facebook, and Instagram have some desirable features, these platforms also have various shortcomings which limit or detract from the user experience on these platforms. For example, a Story created on these platforms is saved and played back as an individual media item within a reader. Hence, the Story generally cannot be readily exported or shared to other platforms or software applications.

Moreover, the manner in which a Story is created on these platforms places constraints on the creative license of the user. In particular, these platforms do not currently allow individual event owners to invite other users (third parties) to create events from a collection of related content, much less from content that belongs to a single user or event owner. Content used to create conventional Stories may be limited only by whatever media a user can obtain through various sources, thus lacking general focus. These platforms also lack a means for allowing the owner of an event to invite third parties to create and/or contribute to Stories related to an event, and to exercise control over how much creative license to give to such third parties in creating or contributing to such Stories.

Some or all of the foregoing shortcomings are addressed with embodiments of the systems and methodologies disclosed herein.

### SUMMARY OF EXEMPLARY EMBODIMENTS OF THE DISCLOSURE

Embodiments of the disclosure can provide systems and methods that provide or enhance a social media platform with collaborative video editing tools that allows multiple users to participate in the creation of event-centric media content (an EventStory), such as a video or a slideshow, using photos, video, audio, etc. collected at live events. The social media platform can be accessed and used via a mobile technology platform such as, e.g., a smartphone or tablet, a wearable device, a laptop, or the like. The mobile technology platforms can be provided with hardware elements capable of detecting their local time and location, communicating with a server and/or other mobile technology platforms, and capturing digital audio, video, and/or photographic media elements. Such hardware elements can be configured to provide access to the installed social media platform.

An Event can be defined using at least one geographical envelope, or geofence, that delineates a geographical area, and at least one corresponding temporal envelope that delineates the time and duration of the Event corresponding to the geofence. Events may further be defined using a plurality of geofences, each having a corresponding temporal envelope.

The social media platform can be used to access stored media captured by the mobile technology platforms, and filter or verify such media that is associated with a defined Event, where such association means the media was captured within both a geographical envelope and a corresponding temporal envelope used to define the Event. In further embodiments, the social media platform can be used to forward some or all of the media captured by the mobile technology platform to a remote server, where verification/filtering and aggregation of media associated with an Event can be performed. Media associated with a defined Event can be obtained from a single mobile technology platform or a plurality of such mobile technology platforms.

To create an EventStory, the social media platform can provide a user interface (UI) that displays thumbnails or other shortcuts representing some or all of the available media elements associated with an Event. The UI can facilitate selection and ordering of such media elements, which may include both video and photographic elements. Modification of individual media elements can also be generated using the UI, such as cropping of photographic images, editing of video clip lengths, display duration of photographic media elements, superimposing of text, filters, and/or other graphical objects on one or more media elements, etc. A sequence of such media elements can be used to generate media content associated with the Event, and may further include certain media elements not associated with the Event in certain embodiments. Transition effects between successive media elements in the sequence can also be added or modified to generate an EventStory, if desired.

Generation of an EventStory can be restricted to a particular mobile technology platform (and associated user) used to define an Event (the EventCreator) and/or one or more further mobile technology platforms (and associated users) granted permission to do so by the EventCreator (e.g., EventOwners). Permissions can also be granted, by EventCreators and/or EventOwners, for further platforms/users to create their own EventStories based on the same Event and/or to modify an existing EventStory. Invitees can include, e.g., other attendees/mobile platforms present at the Event, friends and/or followers of an EventCreator or EventOwner, and/or specific Influencers who may, e.g., be associated with the Event and/or can provide broader exposure for the resulting EventStory. Such modification of existing EventStories can include, e.g., altering the cropping or display duration of individual media elements in the sequence, adding media elements to or removing media elements from the media element sequence, changing the order of media elements in the sequence, etc.

In further embodiments, audio and/or audio+video narration can be added to a sequence of media elements used to generate an EventStory. Such narration can be performed using the mobile technology platform using the UI, which can provide graphical elements and audio/video capture to generate the narration content. Such narration content can be synched to portions of the sequenced media elements, and may optionally be stored in a media file separate from the sequenced media elements. Such separate data files can be useful for maintaining synchronization between narration and the media element sequence during editing of the sequence. In some embodiments, the narration and sequenced media elements can be combined to form a single video file that constitutes the EventStory.

The UI can be used to overlay a video narration element over a portion of the displayed media element sequence. In another embodiment, such video narration can be displayed adjacent to or separate from the displayed media element sequence.

An EventStory, once finalized (with or without optional narration), can be saved and/or ‘published’ as a single media file that includes the sequence of media elements, transitions between such elements, modifications to one or more of the media elements, etc. The published EventStory can be shared via the social media platform used to create it, and/or saved in a conventional digital video file format, where such digital video data file can be shared in a number of ways over almost any social media or digital communication platform.

### BRIEF DESCRIPTION OF THE DRAWINGS

Further objects, features and advantages of the present disclosure will become apparent from the following detailed description taken in conjunction with the accompanying figures showing illustrative embodiments, results and/or features of the exemplary embodiments of the present disclosure, in which:

FIG. 1 shows two screenshots which illustrate the manner in which media content associated with an Event may be accessed for the purposes of creating an EventStory;

FIG. 2 is a series of four screenshots which illustrate the use of a TellingStories feature to invite others to create an EventStory;

FIG. 3 is a series of screenshots which illustrate the association of music sources or the recording of audio during the creation of an EventStory;

FIG. 4 is a series of screenshots illustrating the control of the device camera (front- or rear-facing) during the creation of an EventStory;

FIG. 5 is a series of screenshots illustrating the ability to move the record/music icon and/or the video narration icon either to the left or to the right of the screen during the creation of an EventStory;

FIG. 6 is a pair of screenshots illustrating the selection of an audio file during the creation of an EventStory;

FIG. 7 is a series of screenshots illustrating the playback of an EventStory that has audio+video narration and the ability to move, resize and/or anchor the video narration object anywhere within the displayed EventStory for purposes of playback;

FIG. 8 is a series of screenshots illustrating the manner in which the video-narration overlay may be repositioned anywhere within the screen displaying an EventStory;

FIG. 9 is a series of screenshots illustrating the manner in which thumbnails corresponding to EventStories can be presented to and accessed by a user;

FIG. 10 is a series of screenshots illustrating the manner in which an invitee may utilize features of the TellingStories function;

FIG. 11 is a pair of screenshots illustrating the Invite feature of an EventStory;

FIG. 12 is a series of screenshots illustrating how an EventStory feature can be combined and presented with a conventional Story feature and a TellingStories feature;

FIG. 13 is a series of screenshots illustrating how a conventional Story generation feature can be presented within an EventStory-capable platform; and

FIG. 14 is a series of screenshots illustrating the implementation of an EventStory and corresponding video narration on a multi-display device.

While the present disclosure will now be described in detail with reference to the figures, it is done so in connection with the illustrative embodiments and is not limited by the particular embodiments illustrated in the figures. It is intended that changes and modifications can be made to the described embodiments without departing from the true scope and spirit of the present disclosure as defined by the appended claims.

### DETAILED DESCRIPTION OF EXEMPLARY EMBODIMENTS

Embodiments of the disclosure can provide systems and methods that provide or enhance a social media platform with collaborative video editing tools that allows multiple users to participate in the creation of event-centric media content, such as a video or a slideshow, using photos, video, audio, etc. collected at live events and/or combined with other miscellaneous, personalized photo products. In the present disclosure, such content created by multiple users is referred to as an EventStory.

The systems and methodologies disclosed herein can be implemented using networked social media applications and/or platforms that are configured to provide the features described in the various embodiments herein. For example, embodiments of the disclosure can be implemented within the framework of the PicPocket platform as described, e.g., in U.S. Pat. No. 9,544,379 (Gauglitz et al.), entitled “Systems And Methods For Event Networking And Media Sharing”, U.S. Patent Publication No. 2017/0193617 (Gauglitz et al.), entitled “Systems And Methodologies For Validating The Correspondence Between An Image And An Asset”, U.S. Patent Publication No. 2018/0007149 (Gauglitz et al.), entitled “Use Of A Dynamic Geofence To Control Media Sharing And Aggregation Associated With A Mobile Target”, and International Patent Publication No. WO2016/100601 (Gauglitz), entitled “Drone Based Systems And Methodologies For Capturing Images,” all of which are incorporated herein by reference in their entireties. These exemplary references describe various geofencing-based approaches to the capture, aggregation, sharing, and curation of various types of media and content.

In one embodiment of the disclosure, a social media platform (e.g., PicPocket) can be configured to permit users to define an Event by establishing both a geographic envelope (e.g., a geofence) and a temporal envelope which, with respect to a live event, coincide at least approximately with at least a portion of the time and place of the event. The geographic envelope may be of any suitable or desired shape, size, and/or dimension (including, for example two- or three-dimensional geofences that may include altitude as a parameter). The temporal envelope may be contiguous from start to finish of the event. The parameters defining an Event can be provided, e.g., via a user interface that can include map-based delineation of geographic areas, definition of temporal and/or geographical envelopes thru selectable list items or free-form entry of such information, automatic generation of a geofence and/or temporal envelope associated with an Event based on identification of a live event, etc.

Alternatively, in further embodiments, the temporal envelope may be broken up into a plurality of temporal windows, each of which that can span at least a portion of the event's stated, determined, or expected duration. For example, if the Event occurs over multiple days, the temporal envelope can be defined to span time intervals on two or more of such days, and each time interval can be defined to start and end when the Event begins and ends on a particular day, respectively, or to start and end at some predetermined time before or after the Event starts or ends. For example, a multi-day music festival Event can have a temporal envelope that includes time intervals that begin half an hour before the music festival starts on each day, and ends half an hour after the festival ends on each day. Other criteria can be used to delineate the temporal envelope of an Event. Similar considerations can be used when defining a geofence (or geographical envelope) associated with an Event. For example, an Event that is held at multiple locations at the same or different times (such as, e.g., the World Cup Soccer tournament) can be defined geographically to encompass an area enclosing each stadium in which a match is being played, as well as a corresponding temporal window that encompasses the duration of the match at that particular stadium.

The capture, aggregation, and curation of media content may be done in real time, although such content is not required to be collected or organized at the time of capture. For example, content associated with an Event as described herein may also be collected, organized, and filtered at a later time following an event (or after the start of an event) once spatial and temporal parameters associated with such an event have been obtained and/or defined. Such aggregation and/or filtering of content can be performed by comparing the time and/or location where media or other information was captured, and associating such media with an Event if such time and location fall within the temporal and geographical envelope(s), respectively, defined for the Event. In some embodiments, an “event-within-an-event” may be defined, for EventStory creation, to span a shorter window of time and/or a smaller geographical region than the overall defined Event.

To create an EventStory, a user (e.g., the “EventCreator”) can select one or more media elements (e.g., photos, videos, audio clips, etc) linked to (or associated with) a particular Event, and be provided with a user interface, on-screen commands, or the like, to facilitate arrangement of the media elements in a sequence. Options can be provided for cropping photos, trimming videos, adding subtitles or other text notations, graphics, visual overlays, etc. as desired. Once the user has completed arranging a sequence of media items, the user can be provided with the option to: a) stop the creation process and finish it later; b) publish the EventStory in its current state; c) modify the EventStory by, e.g., recording audio narration, adding music and/or sound effects, etc.; or d) invite another user to take over the creation, editing, and/or completion of the EventStory. If the user decides to invite another user to finish the EventStory, he/she can assign specific permissions defining what the new user can or cannot modify. For example, the second user might be allowed to add narration, but not allowed to rearrange the timeline, or they may be allowed to rearrange some items in the timeline, but not rearrange others.

The ability of a further user to modify an EventStory they have been invited to by the EventCreator can be further expanded. For example, once the second user completes their desired changes, that user may either “publish” the EventStory, or return control of the EventStory to the EventCreator, e.g., for approval and/or final modifications before publishing.

In some embodiments, more than one further user can be allowed to modify an EventStory by the EventCreator. Permission or access to further users for “publishing” the EventStory can be controlled or decided by the EventCreator, who may also control which user(s) can modify the EventStory and/or which aspects of the EventStory may be modified by each further user. For example, each further user can be granted separate permissions relating to the EventStory such as, e.g., permission to publish the EventStory, permission to add certain types of media, audio, graphic overlays, and the like, and/or permission to rearrange components of the EventStory. In another embodiment, a further user can be granted permission to invite still further users to modify and/or publish the EventStory as described above.

The user interface of the social media platform (which may be presented on various types of devices) can be configured to provide alerts to the various users associated with an EventStory. Such alerts can include notification to a further user of access to an EventStory and which modifications the further user may perform, time limitations of such access, the ability of the further user to invite still further users to also modify the EventStory, etc.

In some embodiments, a final media file (EventStory), e.g., a compiled video file, can be created on a user's device (e.g., a smartphone or tablet, a PC, or another networked device having a user interface and access to the social media platform being used to create/modify EventStories) and uploaded to the backend of a particular social media environment, e.g., uploaded into cloud-based storage. Alternatively, the EventStory may be created on the backend based on user input. By storing and continuously updating a single data file in the cloud that represents the current state of the work-in-progress EventStory, users (e.g. the EventCreator and/or one or more further users) can be provided with an option to store a non-final EventStory and finish it later or request that another user take over modifying and/or publishing the EventStory. In some embodiments, when a further user or the EventCreator “takes over” modification of a non-final EventStory, they can import the EventStory data file into their device and proceed to modify it further. The cloud-based stored copy of the EventStory can be locked while a single user has control of modifying it, and then be made available to other users after the single user has finished with their current modifications or merely selects not to modify the EventStory after obtaining control of it.

In some embodiments, a “polling” mechanism can be provided where the device or account of each user associated with an EventStory periodically checks the backend to see if changes have been made by another user, and user interface (UI) features relating to the EventStory (e.g., dater/time and user ID for prior modifications, total file length or size, list of users having access permissions for the EventStory, etc.) may be updated accordingly. In one embodiment, changes to the EventStory, once submitted by a user, are automatically “pushed” by the backend to other collaborators' devices, and the UI is updated accordingly. To maximize performance in either of the two approaches above, only changes to a previous version of the EventStory are communicated between the individual devices and the backend in some embodiments.

In one aspect of the present disclosure, a method is provided for creating video or multimedia content using captured media associated geographically and/or temporally with an event. The exemplary method comprises: (a) providing software (e.g., an app), instances of which are installed on each of a plurality of mobile technology platforms in tangible computer-readable memory, where each mobile technology platform can be associated with one of a plurality of users and is further equipped with a display and a user interface, and where the software may be configured to monitor the current location of the mobile technology platform; (b) creating or defining an Event using the software, where the Event has one or more location envelopes (e.g., geofences) and one or more temporal envelopes associated with it; (c) using the software to aggregate media associated with the Event that is captured and/or provided by one or more users, thereby producing a set of aggregated media; and (d) creating an EventStory using the software, wherein the EventStory can be a video file, an audio file, or a general multimedia file having a plurality of media elements, and where the plurality of media elements include at least one media element captured by a user within the Event (e.g., within the geographical and temporal envelopes associated with the defined Event). In a further embodiment, one or more users may access the EventStory for viewing, modifying, downloading/uploading, granting permissions, etc., via a website-based interface or the like, such as a social media platform website. Such website may be hosted on a remote server, where access to the website features can be controlled, e.g., through an account set up on the platform. Such variety in access options for a social media platform (e.g., app-based or website based, available on a plurality of device types such as smartphones, tablets, laptops, etc.) is known in the art. For example, social media platforms such as Facebook already provide various ways to access the platform on a variety of networked devices.

In one embodiment, the systems and methods described herein can allow media content in an EventStory to be aggregated and stored in a conventional video format. This facilitates export of the final/published EventStory to other software or platforms, and allows the EventStory to be played by various standalone video players or interfaces, independent of the platform on which it was created. Static pictures or other graphic images (e.g. text, stickers, etc.) can be displayed in an EventStory as still images having a selected or defined duration in the video format of an EventStory. Moreover, the systems and methods disclosed herein can allow the owner of an event (the EventCreator) to use their discretion, when inviting other users to modify a single EventStory or create their own EventStories based on the event, as to how much creative license to allow these other users—from selecting, arranging, cropping and/or adorning individual pieces of content with various modifications or effects (e.g., stickers, filters, lenses, graphics, text, etc.) before permitting them to publish or share (audio or audio+video) an EventStory. Such control by the EventCreator can be provided through permissions granted to the further users and/or by giving the EventCreator (or another designated user) final approval of each EventStory before it can be published or shared.

The systems and methodologies disclosed herein may be utilized to support the conventional “Stories” format (referred to herein as “MyStories”). However, the disclosed systems and methods can be utilized to implement a new Stories format, e.g. “EventStories,” which can be associated with a particular predefined Event and allows modification by a plurality of users as described herein. The EventStories format can be published or shared as a conventional audio or video file, as described above.

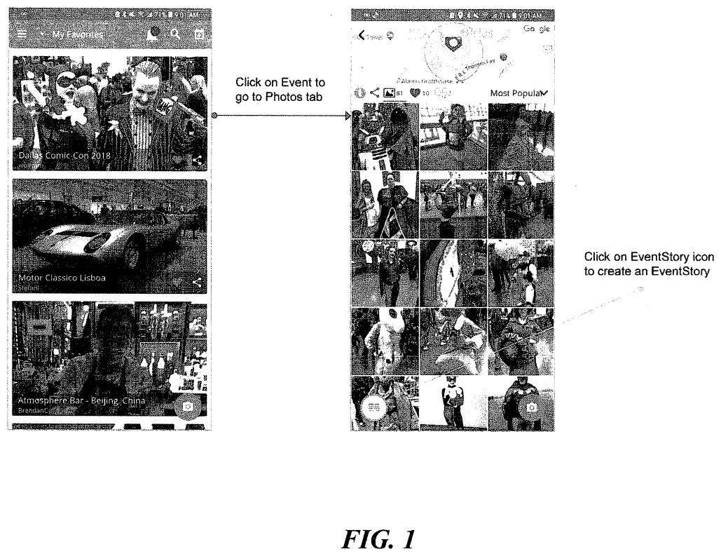

Aspects of various embodiments of the systems and methods of the present disclosure are illustrated, e.g., in FIGS. 1-14. These figures show exemplary screenshots based on the PicPocket application in accordance with embodiments of the disclosure. For example, FIG. 1 shows two screenshots of a user interface in which a plurality of Events are identified on the left-hand screenshot. Selecting an Event then displays a plurality of icons or thumbnails, etc., of captured media associated with the Event. A map image at the top of the right-hand screenshot can indicate the geofence(s) associated with the Event, and can optionally provide a link to a mapping application that displays a more detailed view of the Event location(s).

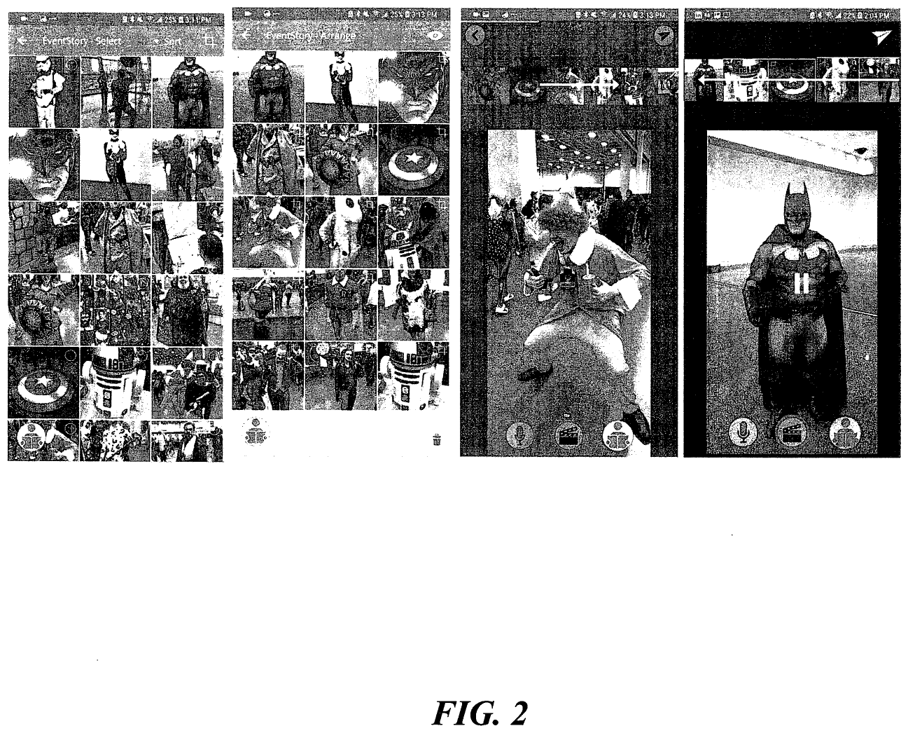

As illustrated in FIG. 2, in some embodiments (e.g., a Pro or Business level of the software described herein), certain users can be provided with a ‘TellingStories’ icon or similar user-selectable control which may be displayed, e.g., in a lower portion of their UI screen. Selecting this icon allows an EventCreator user (and/or someone designated by the EventCreator) to invite other users to create an EventStory. For example, the leftmost screenshot in FIG. 2 shows various media elements associated with a selected Event; the next screenshot shows a user interface that allows sequencing of selected media elements for the EventStory. The next two screenshots in FIG. 2 show a user interface for editing or modifying still images and video clips, respectively, that have been selected for the EventStory. The upper portion of the rightmost two screenshots in FIG. 2 also show a sequence of media elements that represent the EventStory being created or edited, which facilitates selection of individual media elements for editing or modifying.

Users that have such control of the ability to create Stories for a defined event can also be referred to as “owners” of the Event, or EventOwners. Potential invitees may include, for example, attendees of a created or defined Event, Friends (or Followers or users where a mutual Following relationship exists), or members of the social media platform selected from a list of Influencers. The EventCreator may invite a party to create or modify an EventStory at different stages of an Event, extending specific users as much or as little creative license as desired (e.g., selecting up to (n) photos and/or videos associated with an Event, providing a sequential order for pre-selected media items for the EventStory, to only sending a sequence of media items, e.g., in the form of a continuous video for the EventOwner(s) to narrate, further edit, and/or publish/share the EventStory).

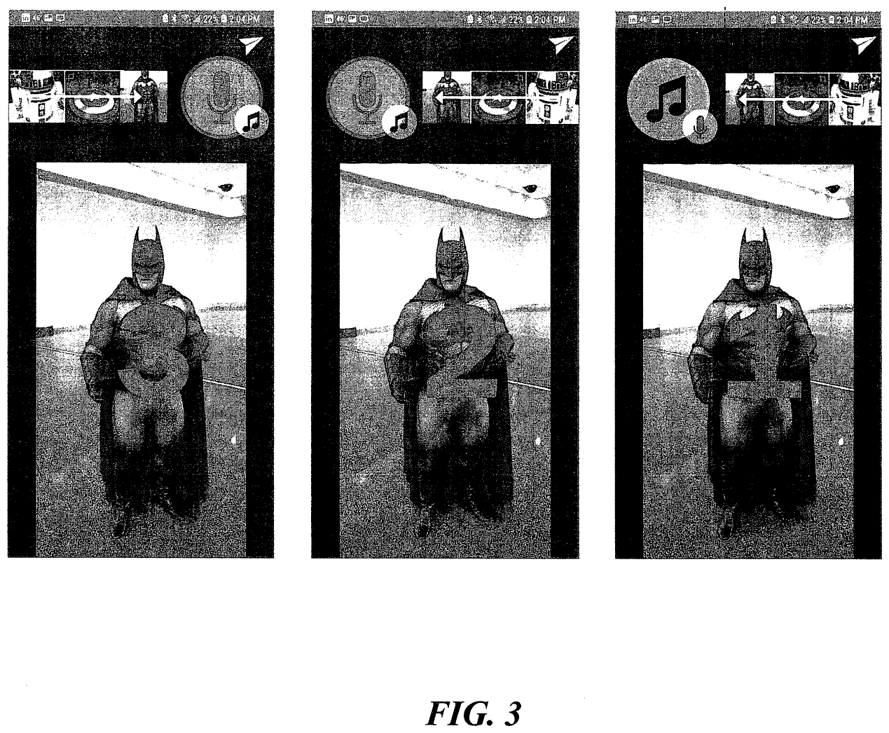

FIG. 3 illustrates elements of a UI that can facilitate the capture of audio recordings or linking of a music file or other audio source to media elements during the creation of an EventStory. As seen in this exemplary interface, the music note and record (microphone) icon can be swapped by user selection. The displayed thumbnail “train” of media elements stops and rolls off before making contact with either the music or audio record icons. A countdown (e.g., from “3” to “2” to “1”, or longer) can be displayed over a selected media element so that the user can prepare themselves to add narration, overdub other audio, etc. The illustrated ability to look ahead in the thumbnail train of media elements also gives users time to formulate their thoughts when adding or modifying audio elements in the EventStory.

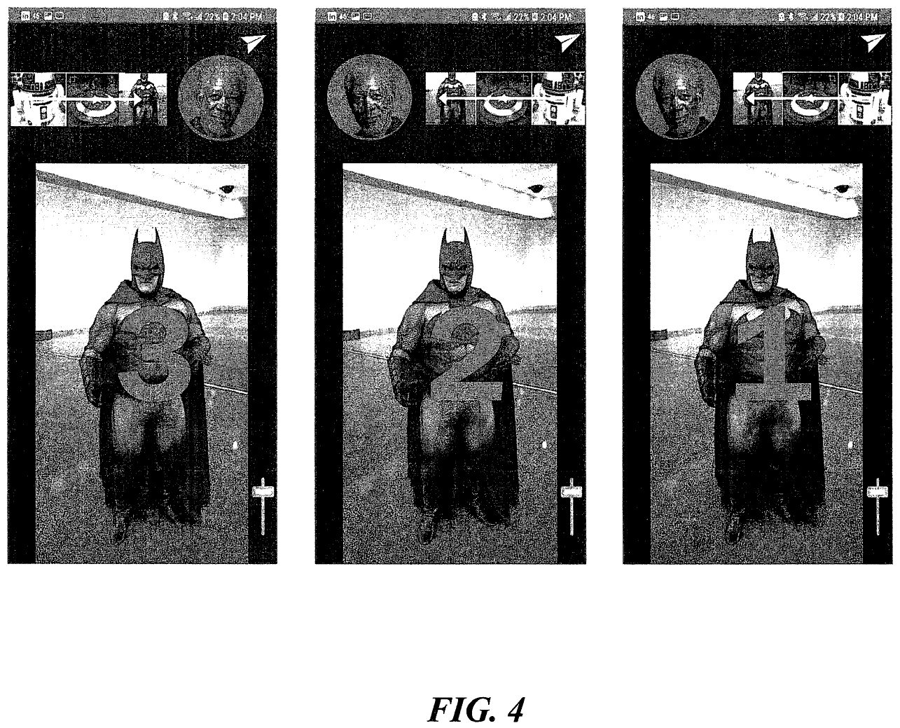

FIG. 4 illustrates an exemplary UI feature that facilitates control of the device camera for capture of media elements during the creation of an EventStory. As seen therein, the slider on the bottom-right of the screen allows the user to zoom the front- (or rear-)facing camera in and out. The location of this slider (and of other UI controls) may vary or be changed per user preference; e.g., the location of the slider may be switched from the right side of the screen to the left side of the screen for left-handed users, or it may be moved higher or lower on the display of the mobile device so as not to conflict with the navigation (touch screen) settings of a mobile OS.

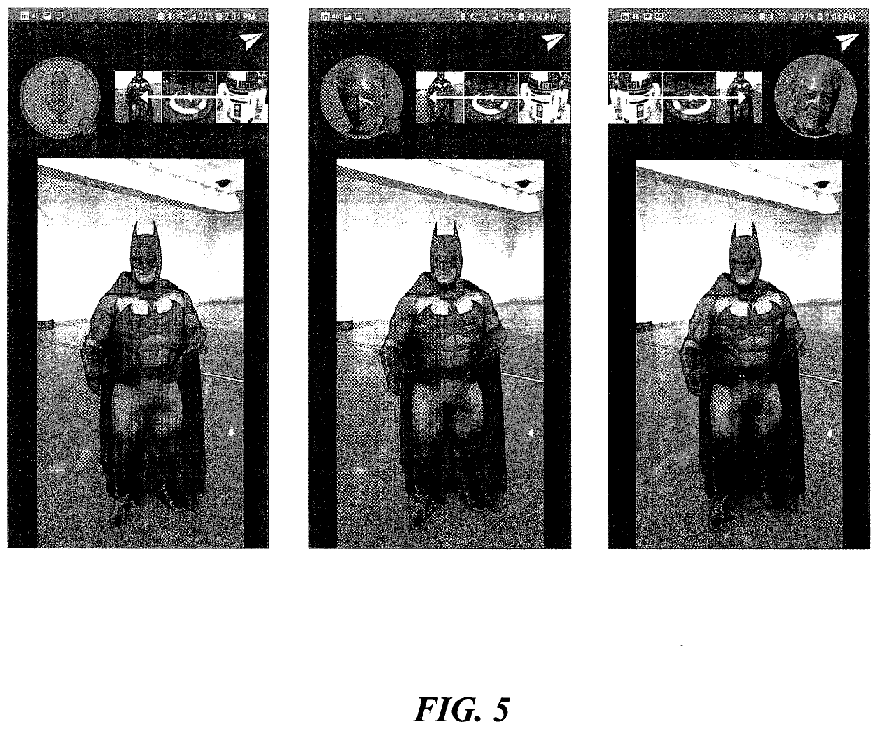

FIG. 5 illustrates the exemplary UI feature of displaying the record/music (microphone) icon and/or video-narration object (showing a narrator's face) on either to the left side or the right during the creation of an EventStory. As seen therein, this may be accomplished by a suitable “swipe left” or “swipe right” action on the part of the user. The app (via the user interface) may optionally provide a default location for the video-narration object that is close to the location of the front-facing camera in a particular mobile device, so as to direct the narrator's gaze into the lens. The ability for the app to ascertain and select a device-specific preferred default location is well-known to those skilled in the art.

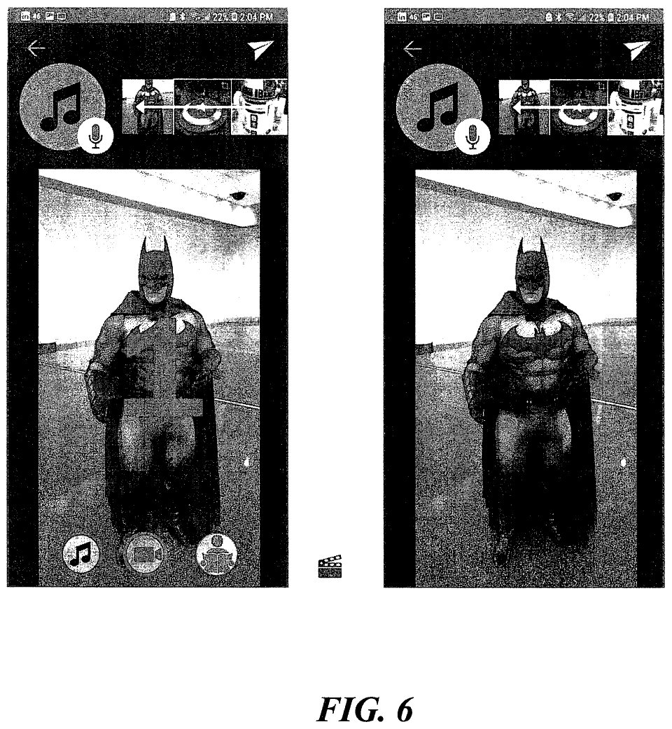

FIG. 6 illustrates another exemplary feature of the UI that facilitates the selection of an audio source during the creation of an EventStory. As seen therein, selection/activation of the music-note icon in the upper left portion of these exemplary screenshots can allow a user to select either a local audio file to play in the background or an audio file from a streaming service. Such internal or external audio source can be used as background for recorded video elements of the EventStory, or it can replace any audio recorded with or added to video elements of the EventStory. Selection of the smaller microphone icon (shown overlapping the lower right portion of the microphone icon) can swap these two icons and switch the audio mode to narration, e.g., through the device's built-in microphone or a connected remote microphone.

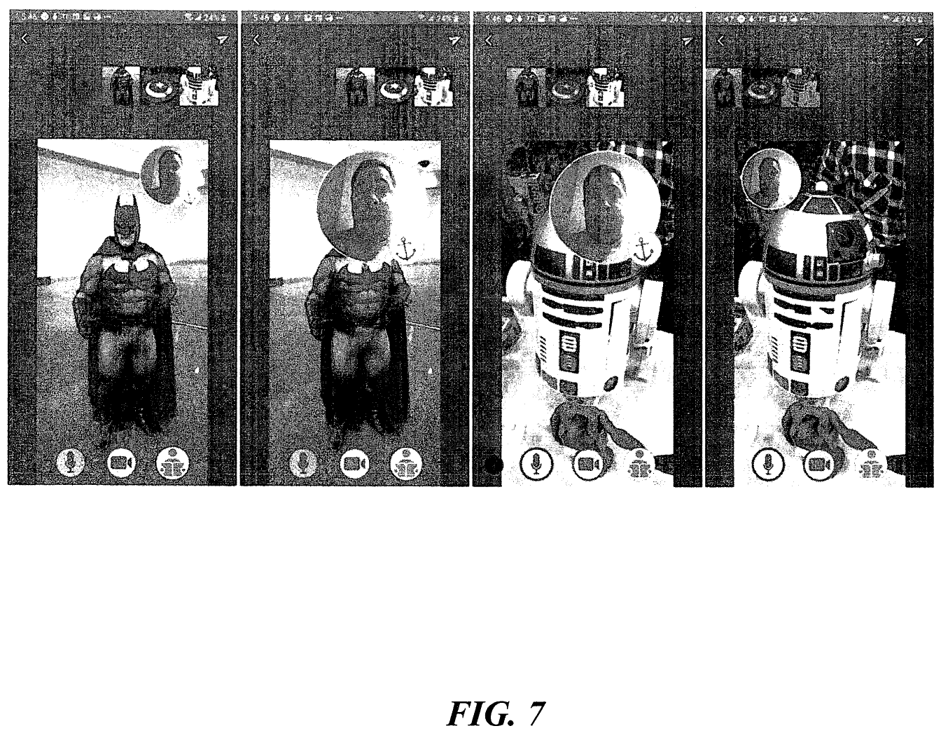

As seen in FIG. 7, when a user watches a completed EventStory that includes an accompanying audio+video narration object (shown here as a face image in a circular object), they can drag the audio+video narration object anywhere within the EventStory video and/or increase or decrease the size of the audio+video-narration object, e.g., by long-pressing and holding the object within the audio+video object space. The “anchor” icon may be selected to finalize the size and the position of such audio+video narration object where the storyteller wishes for it to be fixed in place (immovable), e.g., for those instances where the EventStory may be shared outside of the PicPocket environment to other platforms or as a standalone video. A further embodiment of the anchor feature would allow the EventCreator to save the path of the audio+video object as the Creator drags it around the EventStory video while recording or during preview (playback), but before the completed EventStory is uploaded. If the anchor is not selected, a default size and position of the audio+video-narration object can be established by the user interface, e.g., by the PicPocket application.

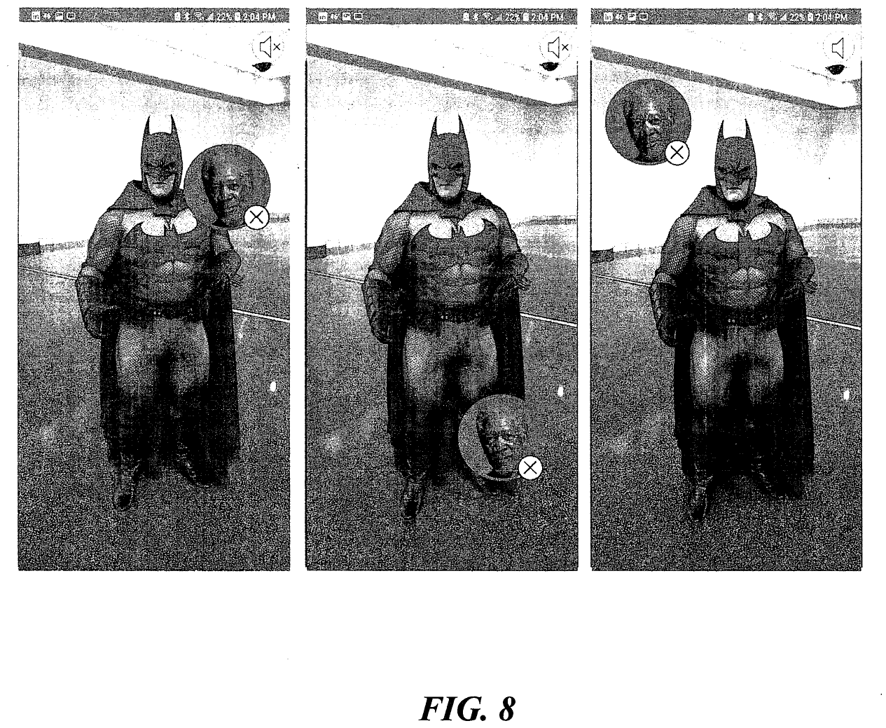

As seen in FIG. 8, when a user watches an EventStory that has an accompanying audio+video-narration object in the app, they can drag the audio+video narration object anywhere within the screen. The “x” icon attached to the narration object may be selected to remove the video object while viewing the EventStory. In certain embodiments, this removal action does not persist, such that the narration video object appears again the next time the EventStory is viewed. The speaker icon may be selected to mute/unmute the audio track. If the EventStory has both narration audio and music and/or video-recorded sound, the speaker icon may be modified to cycle between muting all audio, muting the narration audio, and muting the audio associated with the displayed media itself.

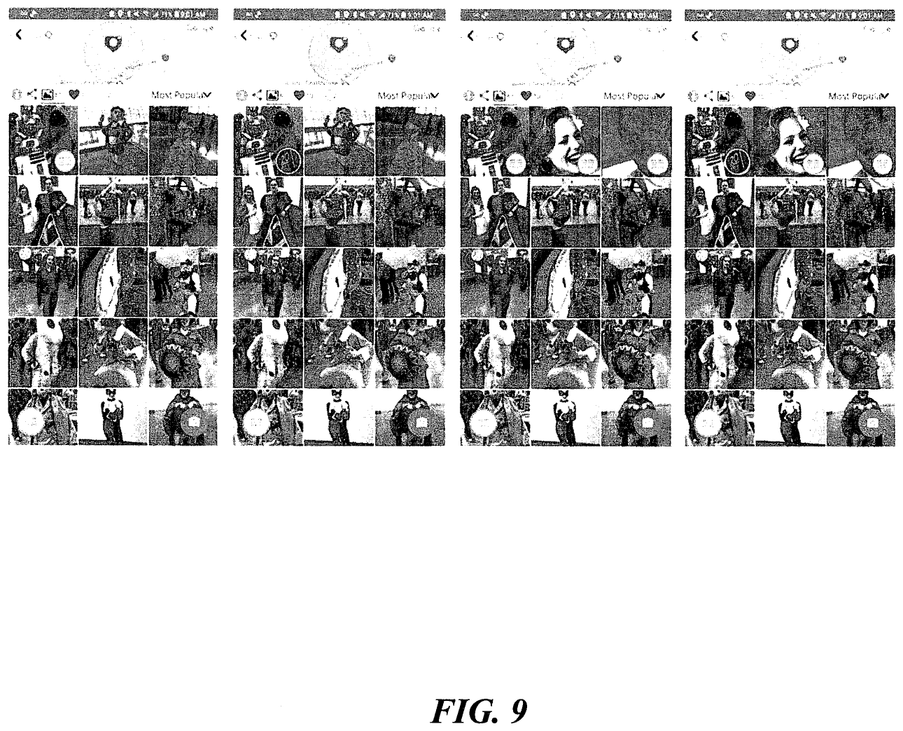

As seen in FIG. 9, an EventCreator's EventStory thumbnail can be represented either by the very first frame of the EventStory, or an individual frame from within the EventStory as selected by the EventCreator, in the illustrated display of media thumbnails associated with an Event. To indicate that a particular thumbnail represents an EventStory, a small indicator such as, e.g., a Storybook icon or the EventCreator's profile photo, avatar, logo, etc. can be displayed on the thumbnail. If a user has not set a personal identifier (e.g. a profile photo, avatar, logo, or the like), they can be sent a notification to set their identifier and the EventStory indicator can default to a generic Storybook icon until such time that the EventCreator's identifier is established. Other users who have permission to create an EventStory for the same Event can have their EventStory thumbnails by their personal identifier or a generic Storybook icon, as shown. Selection of an EventStory thumbnail can initiate a full-screen display of the associated EventStory. EventStories and exported EventStory videos may optionally have a default mute setting and an unmute/mute button toggle.

An EventCreator or EventOwner may create as many EventStories as he/she likes based on their own Events. An EventCreator or EventOwner may also be provided with options to invite other specific users to create their own EventStories based on the Event, and/or grant permission to anyone who attended the Event (e.g., as verified by the presence of a user's mobile device within the geographical and temporal envelopes associated with the Event) to also create an EventStory. Such feature of allowing other users to create their own EventStories for a particular event can be referred to as a ‘TellingStories’ feature. Attendees at an Event and individual users invited by an EventCreator/EventOwner may optionally be allowed to create a single EventStory for the Event, or a limited number of such EventStories. Any attempt to re-record a new EventStory that exceeds the designated limit of such EventStories by anyone but the EventCreator can cause that user's prior EventStory to be replaced with their new EventStory.

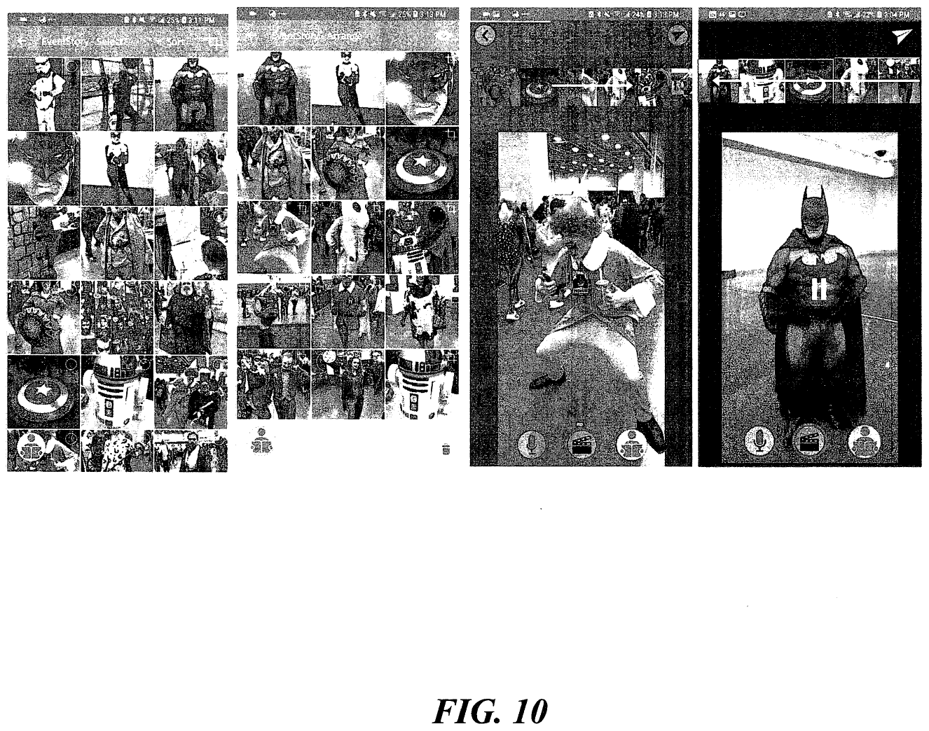

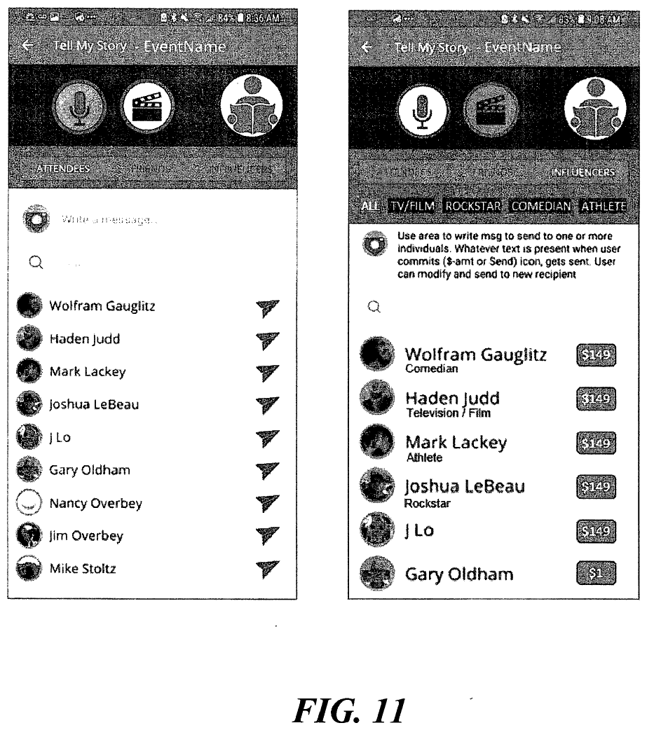

FIG. 10 shows exemplary screen shots of a user interface for creating an EventStory, similar to those shown in FIG. 2, except that the EventStory being created in FIG. 10 is being done by an invited user and not by the EventCreator. FIG. 11 shows exemplary screenshots of a user interface for inviting specific users to create an EventStory based on a particular Event. The right-hand screenshot in FIG. 11 also illustrates the option of offering payment to certain users (e.g., “influencers” or celebrities) to create an EventStory, together with an invite message. Such payment can be sent automatically when the requested EventStory is published, e.g., using a link to any conventional electronic payment application or the like.

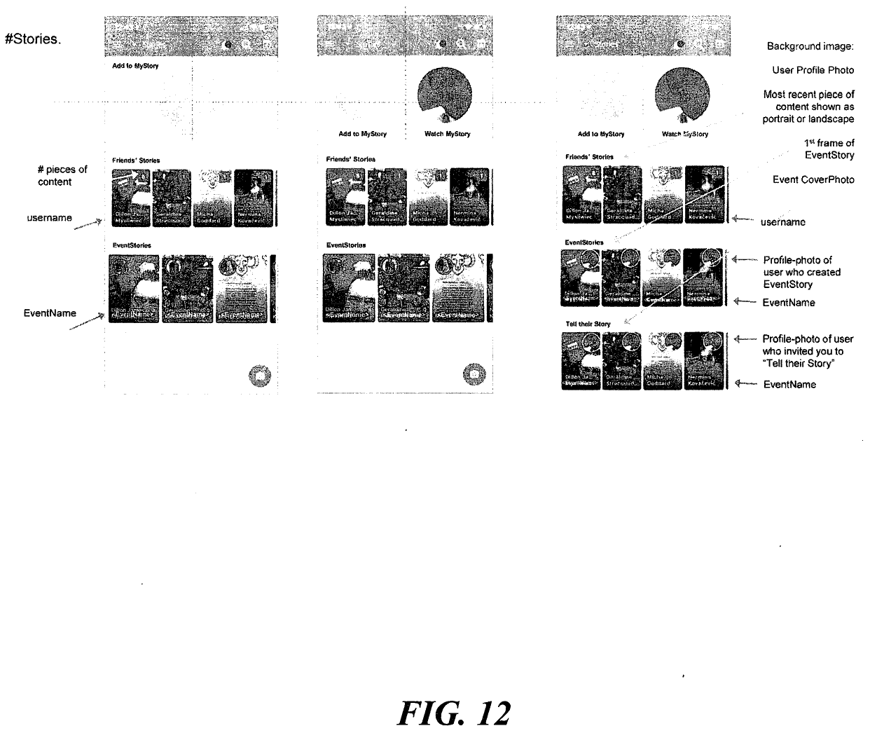

As seen in FIG. 12, a user display can be configured to provide access to a user's conventional Stories as well as their EventStories, as well as Stories (e.g., “MyStory” files) and EventStories belonging to the user's friends and/or followed users. If the user has not created a MyStory yet, or if the latest piece of content the user added to their “MyStory” has become older than 24 hours, only the “+” (Add to MyStory) icon may be depicted at the top of the screen, as shown in the leftmost screenshot of FIG. 12. If content which had been added to ones' MyStory is less than 24 hours old, both the “+” button and the user's profile photo, avatar, etc. can be displayed next to the “+” icon, as shown in the middle and right-hand screenshots. The user's profile photo, if present, can be selected to view (or watch) one's MyStory. Selection of the “+” icon can direct the user to a screen to add content to their MyStory. The UI can be configured, for example, to always display a user's MyStory icon/profile picture at the top of their Stories view.

If a user follows other parties (e.g., friends and/or celebrities) and those parties have added content to their “MyStory” within the last 24 hours, then icons or thumbnails representing the “Friends' Stories” (e.g., “MyStory” thumbnails for everyone the user follows) can be displayed, e.g., on the upper horizontal image strip. If there are no current MyStory files available for any of the user's designated friends and/or followed people, this space can be left blank and preserve its place on the screen, e.g., using greyed-out boxes, an advertisement or message to the user, or the like as a placeholder.

A thumbnail strip below the Friends' Stories strip can be provided that displays and provides access to EventStories that are most relevant to the user. The results displayed in this strip can be automatically generated through the use of an algorithm which may use factors such as, for example, the Events the user has attended, selected or sponsored, or those created by other users that the user follows, or who follow user, other user-specified criteria (such as specific tagged users), or a combination of such criteria. The selection of which EventStories to display can be user-configurable.

An optional “TellingStories” strip of thumbnails can also be displayed, as shown in the bottom portion of the rightmost screenshot in FIG. 12. This is the strip in which a user can be invited to tell someone else's EventStory for them (such telling, or creation of an EventStory, may be on a paid or free basis). Optionally, as shown in FIG. 12, the camera button near the bottom of the screen may be hidden if the “TellingStories” strip is populated.

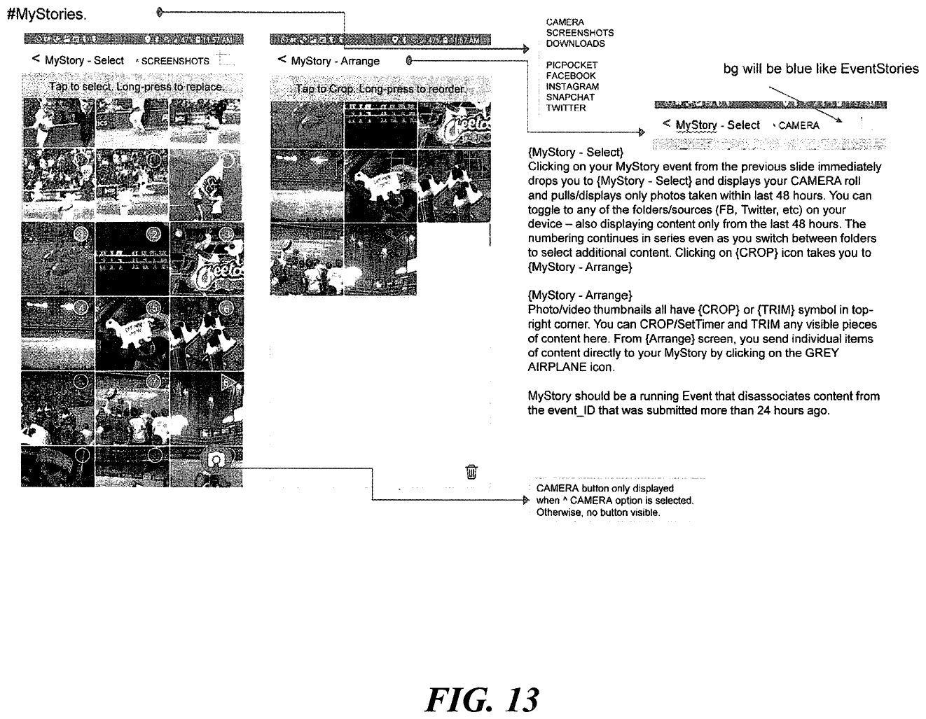

FIG. 13 illustrates exemplary screenshots, including optional user instructions or guidelines, for an interface that may be used to create conventional MyStory files using media available to a user. Accordingly, the overall user interface and application (or social media website) can be used to create both conventional Stories as well as EventStories. Note that conventional Stories may typically use any available media, whereas at least a portion of the media (or all such media if desired) used to generate an EventStory must be associated with the defined Event. Such association can include verification that the media was captured or obtained within the geographical and temporal envelopes that define the Event.

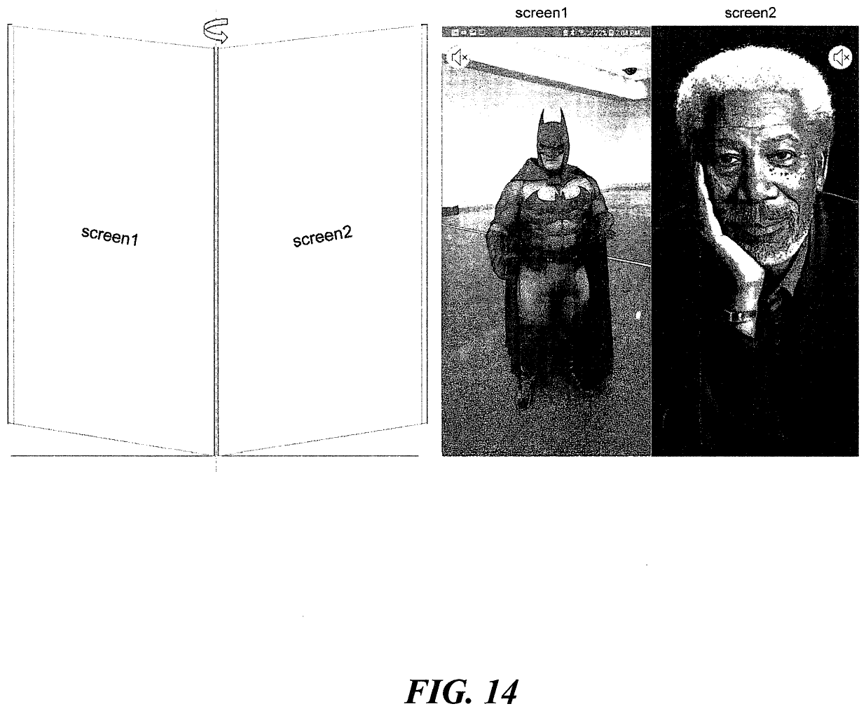

In some embodiments of the disclosure, an EventStory can be displayed on one area of the device's display, and the associated video narration (if present) can be shown on a separate area of the screen, instead of being displayed over the EventStory itself as shown in FIG. 8. In the case of next-generation mobile devices which may have more than one screen, or where the screen may be folded/foldable to give the visual impression of having more than one separate screen, the video for an EventStory (which may have been recorded by either the front or rear-facing camera of the user device) can be expanded to play back a full-screen visual on one screen, with the video narration (if present) being displayed on a second screen, as shown in FIG. 14.

When an Event is created using the PicPocket platform, that Event has a Creator associated with it (referred to as the EventCreator). While the EventCreator will ordinarily also be the owner of the event (referred to as the EventOwner), there is a mechanism for the ownership of an Event to be transferred from the EventCreator or an EventOwner to another user, making the other user now the EventOwner. Such transfer of ownership of an Event can be either permanent or only for purposes of helping to create a specific EventStory. Ultimately, it is the EventOwner who can control administrative rights related to an Event. Such administrative rights may include, but are not limited to, the ability to control the name of the Event (hereinafter referred to as the EventName), related permissions, privacy settings, and/or a list of individuals invited to the Event (hereinafter referred to as the GuestList), permissions to publish one or more EventStories associated with the Event, and/or rights to simply delete the Event. While anyone who has contributed content to an Event preferably has the ability to remove any or all of their submitted content from the Event, the EventOwner may be further allowed to delete any piece of media content from any user which has been associated with one of the EventOwner's Events.

The EventOwner may be permitted to create as many ‘official’ EventStories for each of their Events as they wish. In one embodiment, when an ‘official’ EventStory has been created, a new thumbnail appears in the Event's thumbnail collection of media items with a ‘Storybook’ icon in the lower-right part of the EventStory thumbnail to identify it as an EventStory. The EventCreator's EventStory thumbnail graphic can be selected to be the very first frame of its associated EventStory video, or any other user-selected image contained in the EventStory. The EventOwner may invite others to create an EventStory on their behalf, in which case the third-party EventStory thumbnail can display the profile photo or avatar/logo of the user who created it, as well as an EventStory ‘Storybook’ icon to designate it as a third-party EventStory.

EventStories may be treated like any other piece of content with regard to how they are viewed under different sorting conditions. Apart from the EventOwner, other classes of users may be able to create EventStories of their own for a particular Event. One such class of user is one who has been associated, or has associated themselves, with the Event. This association could be determined in a number of ways including, but not limited to, whether they were: (a) added by a third-party to the GuestList; (b) checked-in to said Event independent of any such invitation; or (c) by having contributed content (photo, video, livestream, comment, etc) to an Event through some form or instance of the social media interface (e.g., the PicPocket application or similar). A second such class of user can be defined as one who receives an invitation to create an EventStory by the EventOwner. In this variation, invited users may create as many EventStories as he or she receives invites from the EventOwner. Users who are invited to create an EventStory are preferably only allowed to create one EventStory per invitation (such that a subsequent EventStory created by that same user for that particular invite/Event will overwrite their existing EventStory). Both implementations may be enforced through permissions by the PicPocket (or other social media) platform—as would other such scenarios that determine whether or not a user other than the EventOwner has permission to create an EventStory of their own.

An Event in the PicPocket platform may be visualized as a scrollable collection of thumbnails. A visual distinction between a photo element and a video element can be made by, e.g., superimposing a semi-transparent ‘Play’ icon (triangle) on top of only the video thumbnails, where a photo will have no such visual indicator. A further distinction between a video and a live-stream video can be indicated by displaying an icon suitable for communicating that the video is being transmitted in real time. All thumbnails can be preferably be sorted and/or filtered by media type, popularity, date/time captured, length of video elements, and/or groups of users. Thumbnails may be selected through long or short-presses, depending on the desired action (e.g., delete, share, etc.) where such actions may be allowed based on ownership or permissions granted to users for the Event in question.

Somewhere on the display of an Event's thumbnail collection (e.g., in the bottom left corner or some other location), a Storybook icon may be displayed for any user who has permission to create an EventStory (hereafter referred to as a ‘storyteller’) for this particular Event. When this icon is selected, the storyteller is presented with a full-screen view of some number of the Event's thumbnails—the remainder of which can be reached by scrolling through the entirety of the collection of Event thumbnails, if they do not all fit on the display at once. The default sort order may be chronological, but other sorting criteria may be selected. Since an EventStory is intended to be a compilation of a plurality of n pieces of content from the full catalog of content associated with an Event, the storyteller can select which n items to include, e.g., by tapping on individual thumbnails. With every selection, the content displays a number designating the ordinal place of the content in the EventStory sequence. An item may be removed from the sequence, e.g. by long-pressing it and optionally dragging it to a trashbin icon or the like.

Once the storyteller has selected n pieces of content to include in an EventStory, they can advance to a further screen where the pieces of content are visually arranged sequentially from 1 to n. Content thumbnails may be moved around like tiles to fine-tune the order of the playback sequence, e.g., by long-pressing and then dragging a thumbnail from to a desired location within the ordered display of thumbnails. An icon may be superimposed on each individual thumbnail to indicate whether the thumbnail represents an image or video type of media element. For example, the thumbnail for a photo may show a crop icon (overlapping right angles), whereas a video thumbnail can display a trim icon (scissors) or a ‘play’ (triangle) icon. Selection of either icon allows the storyteller to crop a photo and/or set the time duration for how long the photo should display as part of the EventStory, or to select just a portion of a video element if desired.

In the case of photos, a user may also switch between a portrait or landscape orientation. At this stage, a user may superimpose text, images, filters, or the like on their final cropped/trimmed selections, and/or designate any one of a number of personalized photo products to superimpose on the image or video. A user may readily change the sequence of content even after it has been cropped, trimmed, or has been otherwise modified, simply by long-pressing on a thumbnail and then moving it anywhere within the sequence of thumbnails. A trash icon on the same screen also allows users to remove a thumbnail at this stage simply by dragging and dropping it over the trash icon. If a user wishes to go back a screen to select additional content to replace an item which was removed, or to simply select different media items, all the crop, trim, timing, ordering, and modifications to the prior media element selections can persist between screens.

Once the storyteller has completed what they believe is their final EventStory, they may click on a Preview icon (e.g., an eyeball) on the screen. If not all of the media which make up the EventStory have already been downloaded and cached, a progress bar or other dialog can be displayed showing the overall progress. Upon completion, the app may then proceed to the “Preview and Narrate” stage of generating an EventStory. If all items are already downloaded and cached, no dialog is displayed and the user interface goes directly to the “Preview and Narrate” stage of generating an EventStory upon selecting the Preview icon.

Each media item is typically bundled with associated data that is based on the type of media item. If an item is a photo or still image, for example, it can be bundled with crop coordinates and/or display duration. If the media item is a video, it can be bundled with trim times. All media items can optionally have date/time and location information specifying when and where they were captured. Such information can also be used to filter or verify media items with respect to a defined Event. The media items remain organized in a sequence corresponding to the order that the user has previously selected during the previous stages of generating an EventStory.

The list of bundled media items can all be sent to a library (e.g., labeled “PPStories”) for processing; this processing can be performed in the background so it does not interrupt use of the app. The PPStories library can be configured to take an ordered list of media items as input, along with crop/zoom/duration/trim/transition effect details/etc., and generate an output video file, optionally with a specified resolution and frame rate. The output video is made up of all the inputted media items stitched together, altered as appropriate based on their associated editing data. Videos with different frame rates may be altered to match the specified output frame rate, e.g. by skipping, interpolating, or duplicating frames. Each item can transition into the next based on a specified transition effect for that item. Such transitions can be performed on both videos and still pictures. Upon exiting the “Preview and Narrate” stage without submitting the EventStory, the EventStory generation is stopped immediately so the in-progress EventStory can be further modified, and processing restarted as soon as the user re-enters the “Preview and Narrate” stage.

Upon entering the “Preview and Narrate” stage, a special player may be displayed to the user that behaves/looks like a conventional video player, but instead of playing a single video it displays what the final EventStory video file will look like. It achieves this by taking in the ordered list of media items bundled with their associated data, and calculating the total duration and the time position of each media item, also taking into account the overlap time in effect transitions between media items. As with a conventional video player, this preview player can be told to seek to a specific time between the start and end time, and then calculate and display the correct media item (or multiple items if the time falls in an effect transition), and play that media item from a calculated offset. The preview player can be configured to play the ordered media items seamlessly, thus appearing to the user that it is playing a single video.

A thumbnail train displaying a thumbnail of every media item in the EventStory can be displayed on the screen during preview viewing (preferably directly below the front-facing camera and above the EventStory video preview, so as to maintain the storyteller's gaze directly into the camera when narration or other storyteller video is being recorded), with the sequence of content thumbnails advancing continuously (e.g., from either the left or the right of the screen), with the thumbnail of the current media item being played visible in the train until trailing off. The user can drag the slider to specify specific locations in the EventStory preview to play.

The thumbnail train advances in synch with the EventStory video at the same rate as which timing was designated on the previous screen for each of the individual pieces of content. As the user previews their EventStory, a background process can be enabled to stitch each of the media content elements together to create a single video file. In most cases, the stitched video will be complete and ready to upload before a user is done previewing their EventStory. The stitching process to create the final EventStory video file can also be initiated by a direct command, without previewing the sequence of media items, in further embodiments.

The displayed thumbnail train during preview allows users to see which elements of content follow the photo or video that is currently being previewed and optionally being narrated by the user, thus allowing the storyteller to prepare and formulate their thoughts more easily when they elect to add audio or video narration to their EventStory. The ability to add audio or video narration can be controlled, e.g., by selecting one of two corresponding icons located at the on the video preview screen.

In some embodiments, the storyteller can narrate audio information to accompany an EventStory during preview and generation of an EventStory, e.g., by clicking a button such as a microphone icon. A visual countdown can be displayed, followed by a record icon (e.g., a flashing red dot) to indicate that the microphone is now recording. As the user records their voice (or background audio) the preview video can continue to play the EventStory preview normally. Users can pause their recording, jump forward and skip recording for a section of the EventStory, or jump back and override audio portions of the EventStory which they have recorded previously. After a user has finished recording their narration, the preview player can play back the video together with the recorded narration audio in synch. Wherever the user jumps to in the video, the accompanying audio is kept in synch and appears seamlessly to the user, even if the user has recorded the audio in fragments. This may be achieved, e.g., by recording the audio in a separate file while previewing, but keeping track of each recorded segment of audio and how it aligns to each segment of the EventStory. Obsolete audio segments that have been recorded over can be removed. Playback of the EventStory can use the ordered list of media elements, or segments, to determine when to play which part of the recorded audio file at what part of the EventStory.

Once the EventStory is finalized and submitted to be published, a new audio file can be created by combining only relevant parts of the full audio recording that correspond to the final media elements being used in the EventStory. The list of segments that track how the audio recording times relate to the EventStory play times are also updated to match the new audio file. The final audio file and its segment data can then be uploaded with the EventStory video file upon the user finalizing his/her EventStory. In this manner, the narration or other audio can be separately muted from the audio contained in the EventStory video file, or vice versa, or relative volumes of the two audio sources (e.g. stitched EventStory video and narration audio) can be separately controlled as desired.

In further exemplary embodiments of the disclosure, a user can also record a video to accompany an EventStory by, e.g., selecting a button on the display (such as a video-recorder icon), allowing the user to record a front- (or rear-)facing video. A visual countdown can be displayed prior to displaying a flashing record icon (red dot) or the like to indicate that recording is taking place. As the user records video narration, the preview video plays back as described above, and the camera viewfinder may also be displayed on the screen (e.g., in the top left corner). The user can optionally relocate the camera viewfinder on the screen, e.g. by swiping it, to best align it with the camera lens on their device. During video narration recording, a user can pause their recording, jump forward and skip narration recording for a section of the EventStory, or jump back and override previously-recorded narration parts of the EventStory.

After a user has finished recording their EventStory's video narration, the preview player can play back the stitched EventStory video and superimpose the user-recorded narration video (e.g., in a small circular window that may be relocatable). Wherever the user jumps to in the EventStory, the corresponding video narration can be kept in synch and made to appear seamless to the user, even if the user has recorded their accompanying video narration in fragments. This can be achieved, e.g., by storing the recorded video narration in a separate file while previewing, but keeping track of each recorded segment of video narration and how it relates to each media segment of the EventStory. Obsolete or unwanted narration segments that have been recorded over can be removed from the narration file, similar to how the audio-only narration file can be manipulated as described above.

Playback of the EventStory can employ the list of media segments to determine when to play specific portions of the recorded video narration file that correspond to portions of the EventStory. Once the EventStory is finalized and submitted (uploaded) for publication or sharing, a new video narration file can be created by the dissection and rearrangement of portions of the full video narration recording, as appropriate, such that the portions of the video narration are associated with corresponding media elements in the EventStory. The final video narration file and its segment data can be uploaded with the EventStory video file upon the user finalizing the EventStory. Optionally, the EventStory video file and the video narration file can be combined into a single overall video file. A similar combination can be optionally performed with the EventStory video file and an audio-only narration file.

The microphone feature for narration can be configured to support either pure audio narration, or the ability to select a music file or other audio file to play in the background as the EventStory video plays. (Such music file may be, for example, a file stored on the mobile device itself, or a file which is streamed via a music streaming service, or the like.) The video recorder feature can be configured to support capturing video from the front- (or rear-)facing camera and audio from the device's microphone or an external connected microphone. Electing either option can start a visual countdown so that the storyteller has a few seconds to prepare for live recording. A flashing red dot or other indicator can be displayed on the screen as a visual cue to remind the user that a recording is underway.

Once a user is satisfied with their preview and subsequent narration, they may click a post (e.g., submit, publish, or upload) button. Upon clicking the post button the EventStory video file generation may continue until completed, and the final EventStory video file can then be uploaded to a server and/or the cloud, and/or saved to local memory storage and/or a specified remote storage location. In addition to (or instead of) saving the EventStory in a proprietary video format, the EventStory can be saved in one or more common and conventional digital video formats. Such video formats can include, but are not limited to, AVI (Audio Video Interleave), FLV (Flash Video Format), WMV (Windows Media Video), MOV (Apple QuickTime Movie), 3GP/3G2 (3GPP—3^{rd} Generation Partnership Project Group and Group2), and MP4 (Moving Pictures Expert Group 4) formats.

Once the upload and/or storage has completed, the EventStory may then appear in the Event's thumbnail collection. Upon selecting the EventStory, the EventStory video file, media narration and media narration segment data (if the narration is not combined with the EventStory video into a single file) is downloaded (or played from a cache). The media segment data is used to make sure the audio narration is kept in sync with the EventStory video playback. If the user had recorded video narration for the EventStory, a floating, circular video player window appears which plays back the video narration while the main video player plays back the EventStory. The floating video narration object can optionally be relocated on the screen, e.g., by dragging it onscreen with a finger, etc. If the EventStory has accompanying narration (audio, video or both), the user can choose to include it or exclude it when sharing the EventStory.

As the audio or audio+video recording is treated as a separate media object, and the narration element typically requires considerably fewer resources to capture and is significantly smaller in size than the content compilation, significant time may be saved in the creation of an EventStory by beginning the content-compilation (stitching) process before the narration is considered. The audio and/or audio+video narration object(s), if provided, may also be combined with the main media-element content compilation in such a way that the entire narrated EventStory can be compiled into a single video object. Such combination into a single video file can facilitate sharing of the EventStory with other social media platforms.

Providing a finalized EventStory product as a standalone video affords users of the EventStory platform (e.g. PicPocket or another such platform) the ability to share an EventStory across all manners of applications and services. By generating this final product in a conventional video format, EventStories may be shared to other social media platforms or services which are otherwise limited to only showing Stories developed within their platforms/applications, to websites, to individuals as email attachments, and the like. The ability of an EventStory to be stored and shared outside of the creating application or platform as a standalone video file is a significant improvement over existing Stories formats—affording significant opportunities for individuals, brands, and/or sponsors to reach a much wider audience.

In further embodiments, the networked storage database for EventStories (e.g., the PPStories library) can be configured to allow pausing mid-processing to allow new EventStory items to be added or to allow existing ones to be removed, from the final EventStory video, in order to increase efficiency. This may be achieved using the following exemplary steps:
1. If the user adds an item (e.g. media, advertisement) to a part of the EventStory that has not yet been processed, a command is issued to the PPStories library to insert that item;
2. If an item is added to the start of the EventStory, the library may update the EventStory file by stitching the new item at the start of the previously-created EventStory video file;
3. If the new item is added to the end of an EventStory that has already been generated, the new item is stitched onto the end of the previously created EventStory video file;
4. If a new item is added to a portion of the EventStory that has already been generated, then:
   a) If generating the video file is still in progress, the current state is recorded and generation is finalized.
   b) The resulting video EventStory file is opened via the PPStories library and frames copied to a new file up to the point where the new item needs to be inserted (e.g., before the effect transition starts, if present).
   c) The new item is processed into the new video file, with transition in/out effects from/to the proceeding and preceding items if transitions are used.
   d) The previously-opened video file skips frames corresponding to transitions that took place between the previous media elements that sandwich the new media element being added.
   e) The rest of the frames of the previously-processed video file are read into the new file.
   f) The saved state of the previous processing is used to continue processing as normal from that point on.
   g) Any associated narration files (audio or audio+video) may be modified to remain synchronized with the new order of media elements in the process file.

Clicking on the Storybook icon from an Event's thumbnails collection may reveal a ‘TellingStories’ (aka StoriesInvite) icon/button. TellingStories is a feature that could be made available (unlocked) to a user based on, e.g., their user-status (such as Free, Pro, Business, etc.), after a user has created their first EventStory, after a user has created some particular number of EventStories, on an Event-specific basis, based on permission from an EventCreator or EventOwner, or based on any other appropriate criteria. This TellingStories icon can be displayed on each successive screen of the EventStory process (Select, Arrange, and Preview). Selecting the TellingStories icon at any time brings the user to a screen where they can choose whether they want the individual(s) they invite to be able to create an audio narration of the EventStory, a audio+video narration version of the EventStory, or any other specific modification to an EventStory.

In one embodiment of the systems and methods disclosed herein, an EventOwner may choose one or more exemplary categories of Invitees for the TellingStories feature (e.g., Event Attendees, friends and/or followers of the EventOwner/EventCreator, and a list of Influencers). These categories may be modified at any time to include different groups of users, depending on the circumstances and particular interests of the EventCreator or EventOwner. When ‘Influencers’ are selected as an option, a subset of categories can be displayed, grouping the Influencers into categories that best reflect how each individual Influencer may be known (athlete, comedian, musician, TV personality, etc.). Depending on which stage of the EventStory process the EventOwner elects to invite a third party to tell on their behalf, the invited third party can receive access to: (1) ALL of the available Event media (e.g., photos and videos) from which to choose up to (n) pieces of media content to create their EventStory; (2) some number (n) of photo and/or video media elements from which to create their EventStory; or (3) the completed EventStory video compilation itself. In the cases of (1) and (2), the user may be free to arrange, crop, trim, arrange, establish timing, and add personalized photo products and effects to their chosen media elements to customize/personalize their version of the EventStory. For (3), Invitees can add audio and/or audio+video narration to the compiled EventStory video.

The EventStory media platform (e.g. PicPocket) may also be configured to optionally add interstitial still or video ads, QR codes, digital coupons, product placements, etc. at the start of, at the end of, and/or anywhere throughout an EventStory. Methods for tracking (from an advertising or digital rights management perspective) where, when, and by whom an EventStory is viewed are well known to those skilled in the art and may also be employed when publishing or sharing an EventStory.

The ability to extend the time allotted for an individual piece of content (regardless of what had previously been set/defined) whilst recording accompanying audio or video narration is also contemplated. This can allow the storyteller some flexibility in describing photo content as they begin to narrate their EventStory. One manner in which this may be achieved when narrating an EventStory (in either the audio or video mode) is as follows. If a user wishes to stay on a piece of content to record longer than whatever duration was decided upon at the time of the crop/trim decision, the user may hold their finger on the photo to pause/freeze the thumbnail train. The time element may be modified to coincide with the length of the video recording for that particular piece of photo content. This capability may be extended to video media elements as well, for example, through accommodating the length of a corresponding narration sequence by slowing down the video sequence, by looping the video segment itself at its normal framerate, and/or by pausing on the last frame (or one or more selected frames) of the video sequence to adjust the length of the video segment to the corresponding narration segment.

The foregoing merely illustrates the principles of the present disclosure. Various modifications and alterations to the described embodiments will be apparent to those skilled in the art in view of the teachings herein. It will thus be appreciated that those skilled in the art will be able to devise numerous techniques which, although not explicitly described herein, embody the principles of the present disclosure and are thus within the spirit and scope of the present disclosure. All patents and publications cited herein are incorporated herein by reference in their entireties.

1. A method for creating video content from media captured at an event, the method comprising:
providing software, instances of which are installed on each of a plurality of mobile technology platforms, wherein each mobile technology platform is associated with one of a plurality of users, wherein each mobile technology platform is equipped with a tangible computer-readable memory device in which an instance of said software is installed and is further equipped with a display, and wherein said software monitors a current location of the mobile technology platform;
defining the event based on at least one geographical envelope and at least one temporal envelope associated with the event;
using the software to aggregate media associated with the event, thereby producing a set of aggregated event media elements, wherein each media element comprises at least one of a still image, an audio file, or a video clip, and wherein media associated with the event consists of media elements captured within both the at least one geographical envelope and the at least one temporal envelope associated with the event; and
creating an EventStory using the software, wherein the EventStory comprises a plurality of sequenced media elements including at least one media element selected from the set of aggregated event media elements, and wherein the EventStory has the form of one or more multimedia data files,
wherein creating an EventStory using the software comprises providing permission to a plurality of users to modify at least a portion of the plurality of sequenced media elements.

2. The method of claim 1, wherein said EventStory comprises a plurality of media elements selected from the set of aggregated event media elements.

3. The method of claim 1, further comprising adding at least one of audio narration or audio+video narration to at least a portion of the plurality of sequenced media elements.

4. The method of claim 3, wherein at least a portion of the narration is synched to at least a portion of one or more of the sequenced media elements, such that the portion of narration remains synched to the portion of at least one or more of the sequenced media elements when the sequence of media elements is modified.

5. The method of claim 1, wherein the EventStory is a video file having a format selected from the group consisting of AVI (Audio Video Interleave), FLV (Flash Video Format), WMV (Windows Media Video), MOV (Apple QuickTime Movie), 3GP/3G2 (3GPP—3^{rd} Generation Partnership Project Group and Group2), and MP4 (Moving Pictures Expert Group 4) formats.

6. The method of claim 1, wherein said EventStory consists only of media elements selected from the set of aggregated event media elements.

7. The method of claim 1, wherein said EventStory further comprises at least one of a text overlay, a graphical filter, a sticker, a displayed advertisement or a link to a music file to be streamed by a music streaming service when viewing the EventStory.

8. (canceled)

9. The method of claim 1, wherein modifying at least a portion of the plurality of sequenced media elements comprises at least one of adding at least one media element, removing at least one media element, altering at least one of a size, duration, or appearance of at least one media element, providing at least one of audio narration or video narration to at least a portion of at least one media element, or changing the ordering of at least one media element relative to the other media elements in the plurality of sequenced media elements.

10. The method of claim 1, wherein the set of aggregated media elements associated with the event is provided by a plurality of the mobile technology platforms.

11. The method of claim 1, further comprising providing a graphical user interface on the plurality of mobile technology platforms to facilitate display of the set of aggregated media elements associated with the event and generation of the sequence of media elements used to create the EventStory.

12. A system for creating video content from media captured at an event, the method comprising:
a networked server configured to provide instances of software a plurality of mobile technology platforms, wherein each mobile technology platform is equipped with a tangible computer-readable memory device in which an instance of said software is installed, and wherein said installed software instance is capable of monitoring a current location of the mobile technology platform;
wherein the server is provided in communication with the plurality of mobile technology platforms and is further configured to:
receive a plurality of audio and/or video media elements from a plurality of the mobile technology platforms using instances of the installed software;
aggregate media associated with the event, wherein the event is defined by at least one geographical envelope and at least one corresponding temporal envelope, and wherein media associated with an event consists of media elements captured by the mobile technology platforms within both the at least one geographical envelope and the at least one corresponding temporal envelope;
provide access to the aggregated media associated with the event to at least one of the mobile technology platforms;
receive a sequence of media elements that comprises media elements associated with the event from the at least one mobile technology platform,
provide permission to at least two of the plurality of the mobile technology platforms to modify at least a portion of the plurality of sequenced media elements; and
generate the video content associated with the event based on the modified sequence of media elements.
